(19) United States
(12) Patent Application Publication
(10) Pub. No.: US 2002/0194215 A1
(43) Pub. Date: Dec. 19, 2002

(54) Advertising application services system and method

(76) Inventors: Christian Cantrell, Reston, VA (US); Mark L. Helmstetter, Chantilly, VA (US); Benjamin Simon, Arlington, VA (US); Patrick Transue, Springfield, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/173,657

(22) Filed: Jun. 19, 2002

Related U.S. Application Data
(63) Continuation-in-part of application No. 09/726,422, filed on Dec. 1, 2000.
(60) Provisional application No. 60/244,207, filed on Oct. 31, 2000.
(60) Provisional application No. 60/299,173, filed on Jun. 20, 2001.

(51) Int. Cl. G06F 17/21; G06F 17/24; G06F 17/60; G06F 15/00; G06F 17/00

(52) U.S. Cl. 707/500; 705/14

(57) ABSTRACT

The present invention provides a system and method for provisioning an advertising application for publishers. This advertising application provides advertisers with the tools to generate and control an advertising campaign. In one embodiment, the service is designed to run as one instance of the application, while supporting a multitude of publishers.

The present application is a continuation-in-part of Non-Provisional application Ser. No. 09/726,422, entitled “System and Method for Enabling User Control of Online Advertising Campaigns,” filed Dec. 1, 2000, which claims priority to Provisional Application No. 60/244,207, entitled “Media Manager,” filed Oct. 31, 2000. The present application also claims priority to Provisional Application No. 60/299,173, entitled “Advertising Application Service Provisioning,” filed Jun. 20, 2001. Each application identified above is incorporated herein by reference in its entirety.

### BACKGROUND OF THE INVENTION

This invention relates generally to electronic advertising, and more particularly to an advertising application provisioning service.

Many internet-based companies have a significant if not an entire dependency upon revenue generated by the sale of advertising space (inventory) on their web site. These sites have historically depended upon large ad networks (i.e., DoubleClick, Flycast, 24×7, etc.) for the sale of their ad inventory. In the late 1990's CPM rates (the cost of advertising in units of one thousand impressions) ranged from $20 to $35 and more. Large corporations spent huge sums of money on online advertising, spawning the growth of many portals, ad-sponsored “free” ISPs, and other web businesses.

Now, in mid-2001, CPM rates have fallen precipitously, to a point where these web sites, still dependant upon advertising for their viability, are getting as little as $0.25 per thousand ads appearing on their site. This is partly attributed to the decline in click-rates (a metric for evaluating the effectiveness of the ads), partly because fewer companies are spending money to advertise on line, and partly because of simple rules of supply and demand. Many, if not most, mid to large-sized web sites are reporting excess ad inventory (unsold space on the sites available for ads) of more than 70 percent. This unsold inventory becomes relegated to the display of ‘house ads’ or default ads sent by the ad networks, for which the web site gets no revenue.

Two factors can determine whether internet advertising can continue to serve these web sites effectively by providing significant revenue. The first factor relates to a broader group of businesses turning to the internet for advertising (increasing the demand for inventory). Currently fewer than one hundred large corporations account for more than 80% of spending. Clearly, a broader base of businesses need to be convinced of the value of internet advertising. The second factor relates to a vehicle for websites to reach these businesses directly and cost-effectively, eliminating the need for middlemen such as the ad networks, ad agencies, etc., which make the costs prohibitively expensive for the advertiser and the publisher (web site), and reducing the dependency on internal sales forces.

### SUMMARY

The present invention provides a system and method for provisioning an advertising application for publishers that allocate space for ad content. This advertising application provides advertisers with tools for generating and controlling an advertising campaign. In one embodiment, a service is designed to run as one instance of the advertising application, while supporting a multitude of publishers.

### BRIEF DESCRIPTION OF THE DRAWINGS

FIG. 1 illustrates an embodiment of a web page including an advertising link.

FIG. 2 illustrates an embodiment of a login screen.

FIG. 3 illustrates an embodiment of an ad type screen.

FIG. 4 illustrates an embodiment of an ad definition screen.

FIG. 5 illustrates an embodiment of an ad preview screen.

FIG. 6 illustrates an embodiment of a target selection screen.

FIG. 7 illustrates an embodiment of a campaign scheduling screen.

FIG. 8 illustrates an embodiment of a campaign directory screen.

FIG. 9 illustrates an embodiment of an ad serving network.

### DETAILED DESCRIPTION

An embodiment of the invention is discussed in detail below. While specific implementations are discussed, it should be understood that this is done for illustration purposes only. A person skilled in the relevant art will recognize that other components and configurations may be used without departing from the spirit and scope of the invention.

In accordance with the present invention, web sites are given a vehicle for generating revenue from their unsold ad inventory. As will be described in detail below, end-users can be provided with the tools to generate and control an advertising campaign. This cost-effective framework obviates the need for middlemen such as the ad networks, ad agencies, etc.

In one embodiment, the present invention is implemented as a software application that is run as an ASP-service (Application Service Provider) on behalf of publishers (web sites relying upon advertising revenue). This ASP-service provides a set of tools that enable the creation of advertising content, definition of an ad campaign, payment for the ad campaign and ad campaign management—all by a novice end-user.

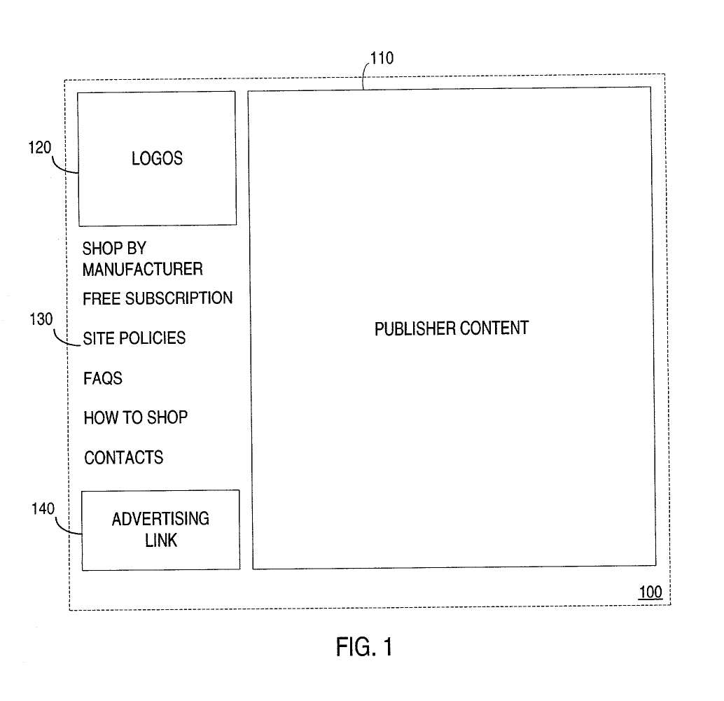

In one embodiment, access to the ASP-service is provided via a link from the publisher's web site. FIG. 1 illustrates an interface screen 100 that can appear as part of a publisher's web page. Interface screen 100 can include such conventional web page items as publisher content 110, logos 120, and menu 130. Additionally, interface screen 100 also includes advertising link 140, which enables a user to access the ASP-service.

By providing advertising link 140 to the ASP-service, the publisher enables businesses to easily and cost-effectively build ads (the creative media), and have the ad displayed on that specific publisher site (or other sites of their choosing). It is expected that this will open up the advertising market to businesses that have to date not pursued online advertising because it was too costly, too confusing, and nearly impossible to control the distribution of the ad to a select market/target.

In one embodiment, the ASP-service is designed to run as one instance of the ASP application, while supporting a multitude of publishers. Each of these publishers can define custom attributes within the context of this single application, making key ASP-service features meet their specific requirements. In many situations, this embodiment enables the ASP-service to support many publishers cost-effectively by dramatically reducing the cost of building what otherwise would be one-off (or individual) applications for each. A further advantage of this embodiment is its ability to greatly reduce the time-to-market, a strategic advantage for the owners of the ASP-service.

In one embodiment, each page within the application's user interface has publisher-specific content dynamically displayed to the user. This content can include graphics (e.g., logos and other branding elements), publisher-specific ad templates, targets and advertising pricing. The content is read from database tables dynamically, thereby giving the application the appearance of being unique to that publisher.

This flexible, table-driven design means that publishers can easily be added by simply defining new entries in database tables, thereby keeping development costs at a minimum and licensing costs very reasonable for the ASP customers.

In one embodiment, the ASP-service is a program that allows an advertiser, to easily create an ad by selecting an ad objective (or ad type), entering data (text and images) to appear in the ad, and then selecting from one or more ads that are automatically rendered. These ad types, data elements and ad templates (backgrounds), can all be definable by the publisher.

Additionally the ASP-service can enable the selection of a target audience (viewers of the ads). These audience targets are definable by the publisher and are highly flexible. Targets typically (but not necessarily) relate to the location of the ad on a web site, attributes of the viewer (e.g., zip code), the content being displayed, etc.

Furthermore, the ASP-service can enable the selection of and payment for an advertising campaign. Campaigns can be defined by a variety of factors, each definable by the affiliate. These factors can include the type of advertising campaign (e.g., number of impressions delivered (instances of ads displayed on a browser), the number of clicks, position on a web page, etc.), term of the campaign (days, months, etc.), and cost.

Finally, the ASP-service can be designed to provide reports for both the advertiser and the publisher. These reports display campaign performance data and, for the publisher, management information system information on advertisers, revenue, and inventory requirements.

Having described a framework for the ASP-service, an example embodiment of the ASP-service is now described. As noted in the illustrated embodiment of FIG. 1, an advertiser is first presented with interface screen 100, which includes advertising link 140. In one embodiment, advertising link 140 enables access to the ASP-service by pointing to the uniform resource locator (URL), “http://<publisher name>.advariant.com”.

As noted above, the ASP-service can be run as one instance of the application. The application can therefore be designed to distinguish between publishers, and in doing so retrieve the necessary information from database tables to display appropriate branding elements, ad types, templates, payment plans, etc. that are defined for the specific publishers. This makes the application appear to be unique with respect to each publisher, and makes the implementation of publishers highly efficient.

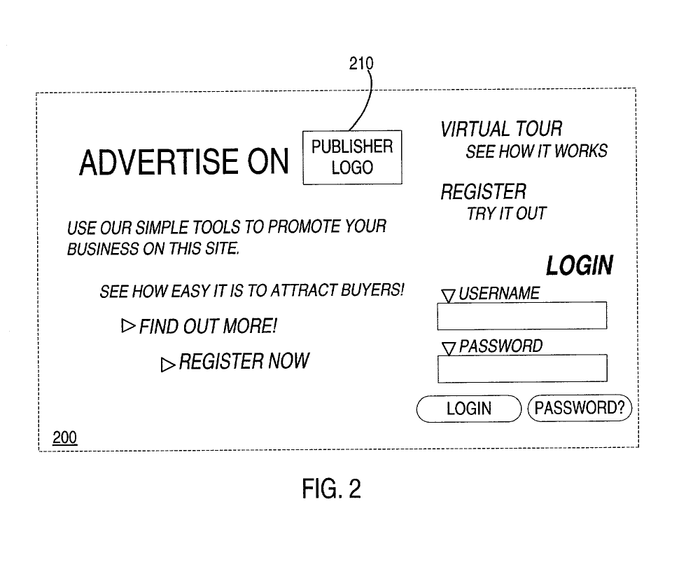

When an advertiser clicks on advertising link 140, the advertiser is presented with login screen 200 of FIG. 2. Login screen 200 can include the logo 210 of the publisher as well as any custom text (promotional messages) that introduce the advertising service.

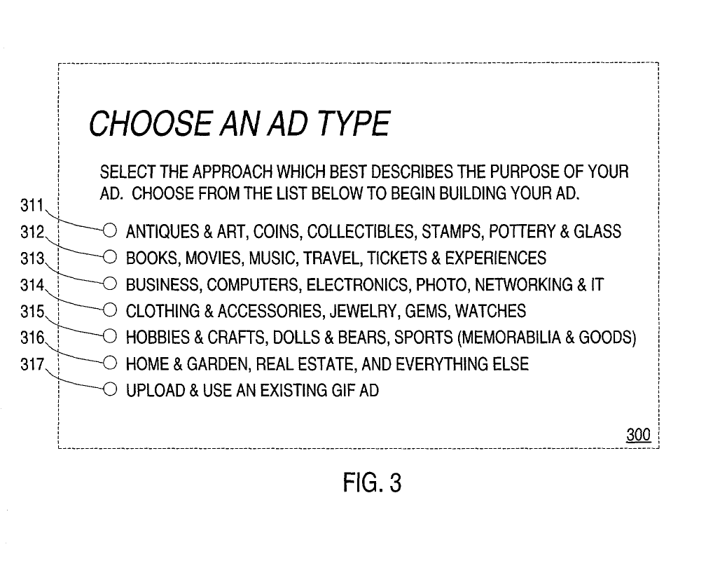

Once the advertiser has registered and logged into the ASP-service, the advertiser is then presented with ad type screen 300 of FIG. 3. Ad type screen 300 represents the beginning of the ad creation process. Here, the advertiser is called upon to define the general objective of the online ad. In the illustrated embodiment, the advertiser can indicate a desired ad purpose through the selection from a set of ad types using radio buttons 311-317. In the illustrated embodiment, ad types are used to select from different product categories that are available on an auction site.

In general, the different focus of each of these ad types suggests that a different ad design may be used. As all advertising campaigns are not created equal, variations in theme would dictate variations in the design of the ad. In one embodiment, ad types are definable by the publisher. As in the example of ad type screen 300, these ad types may reflect product categories, or in other cases the target market (e.g., ads directed towards women), or general ad objectives such as the creation of brand awareness, promotion of a service, etc.

The ad type can dictate the data elements the advertiser is prompted to enter. Additionally, the ad type can dictate the final appearance and behavior of the ad (how the data elements are handled). Both the ad type and the data elements can be defined by the publisher and retrieved dynamically.

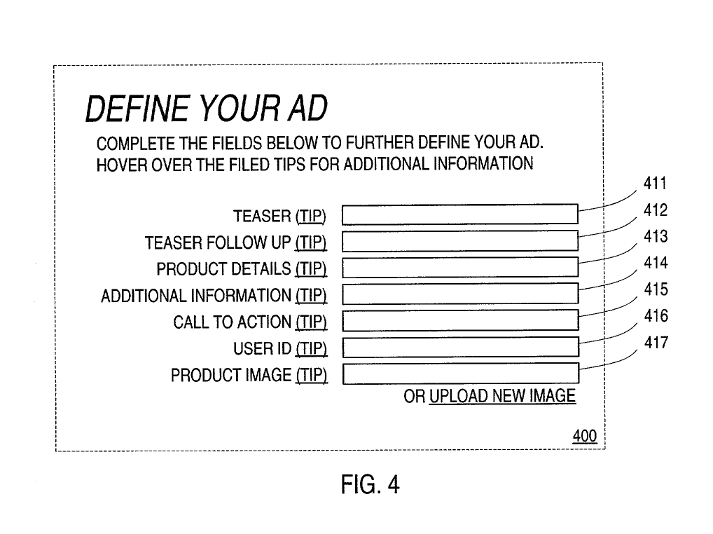

FIG. 4 illustrates an embodiment of an ad definition screen 400. Ad definition screen 400 includes data elements that are definable by the publisher and that are handled programmatically to render sets of ads for the advertiser's selection. Along with the custom data fields 411-417, the field labels (Teaser, etc.) as well as the “tips” can also be defined by the publisher. In general, the data elements in ad definition screen 400 can include the core advertising content that is to be displayed within the ad. For example, the core advertising content can include a description of a product, a description of a service, a description of a brand, or the like.

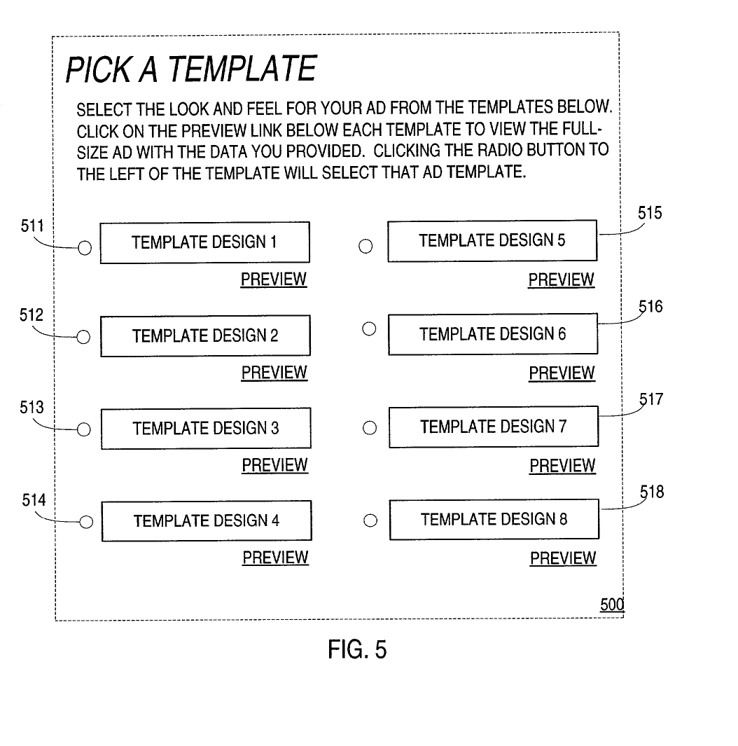

After the advertiser has entered the ad data into ad definition screen 400, the advertiser is then presented with ad preview screen 500 of FIG. 5. Ad preview screen 500 displays a plurality of ads that have been generated in accordance with the ad type and the provided ad data. Each of the displayed ads is based on a template that is associated with the selected ad type. The various ad templates are populated with the ad data that is provided by the advertiser.

The collection of ads is generally designed to account for the spectrum of ad design options that would be appropriate for the particular ad type. For example, the collection of ads can be used to specify various combinations of font styles, background graphics, scene/slide layouts, scene/slide transitions, etc. Through the display of the plurality of preview ads, the user can simply survey the various options and select the ad that is most suitable for the intended advertising campaign. This selection is enabled through radio buttons 511-518. It should be noted that the ads that are rendered for the advertiser's selection come from a database and can be specific to the publisher. For example, a publisher can select ad sizes of any size, 468×60, 125×125, 120×90 pixel, etc. Ad size options are driven by parameters stored in the database and are reflected dynamically in the user interface.

It should also be noted that ad preview screen 500 can also be configured to display only a single ad. This embodiment may be used in those situations where the ad design options are limited to an accepted, standardized ad configuration.

As thus described, the ad creation process need not be based on the specification of the entire set of specific design parameters for the ad. Rather, the ad creation process can be based on the specification of an ad type and the corresponding core content without having to consider the host of design parameters that are necessary to create a single viewable ad. A detailed description of this ad design process is found in co-pending U.S. Patent Application No. 09/726,422, entitled “System and Method for Enabling User-Control of Online Advertising Campaigns,” filed Dec. 1, 2000.

After the advertiser has selected an ad using one of radio buttons 511-518, the advertiser is then presented with target selection screen 600 for selection of a target for the advertisement. It is a feature of the present invention that each publisher can set its own targets, which are drawn dynamically from database tables.

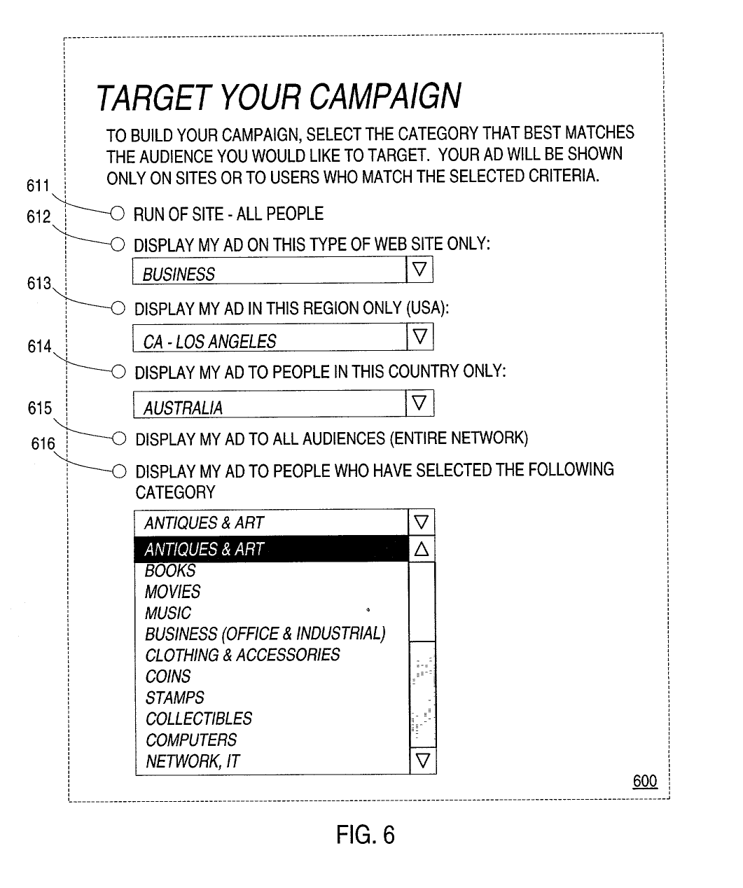

Target selection screen 600 of FIG. 6 illustrates examples of various targets that can be defined. First, an advertiser can select a run-of-site target using radio button 611. This target specifies that the ad is to be run on the entire website of the publisher. This option represents the most basic intent of the advertiser in deciding to advertise on a selected website. As noted in the illustration of FIG. 1, this intent is evident in the initial selection of advertising link 140, which appears on the desired website.

Alternatively, an advertiser can choose to advertise on a target that goes beyond a particular website to a set of websites. In the example of FIG. 6, the advertiser can select set-based targets using radio buttons 612 and 615. These set-based targets enable an ad to be displayed on a plurality of websites. In the case of the target associated with radio button 612, the ad can be displayed on a set of websites that has been defined by an element of categorization (e.g., business, sports, entertainment, etc.). In the case of the target associated with radio button 615, the ad can be displayed on a set of websites that has been defined by an existing network relationship (e.g., affiliate network).

In contrast to the display of an ad on a set of websites, an advertiser can also choose to define a target that represents a portion of a website. As would be appreciated, the level of granularity in defining a portion of a website is implementation dependent. The targets associated with radio button 616 illustrates one example of a level of granularity that can be defined in the context of an auction site that segments categories of items being auctioned. In this example, the auction website can be segmented by subject matter. Thus, in this example, an advertiser can specify one or more categories from the set including Antiques & Art, Books, Movies, etc. Based on the advertiser's selection, the advertising campaign would operate such that the ad would be displayed on those pages that are associated with the selected product categories.

In addition to the specification of a target based on the characteristics of a particular website or group of websites, a target can also be defined based on one or more characteristics of the audience of the advertisement. For example, as illustrated by the targets associated with radio buttons 613 and 614, the campaign can be defined based on the geographic location of the user that will be viewing the ad. In one embodiment, the geographic region of the user can be identified based on a zip code associated with user. As would be appreciated, information about the user, no matter how it is obtained or tracked, can be used as part of the specification process in defining a particular audience of the ad. In this framework, an ad will be displayed to a particular user only when it is determined that the user meets some predefined set of one or more criteria. In various embodiments, these criteria can be defined based on the analysis of one or more pieces of information that are reflective of a physical or psychographic profile.

Here, it should be noted that the target campaigns of target screen 600 have been provided by way of example and are not intended to limit the scope of potential targets that can be defined by a particular publisher. In general, an advertising campaign can be defined in an way that leads to the specification of a target representative of a subset of the universe of ad viewing possibilities.

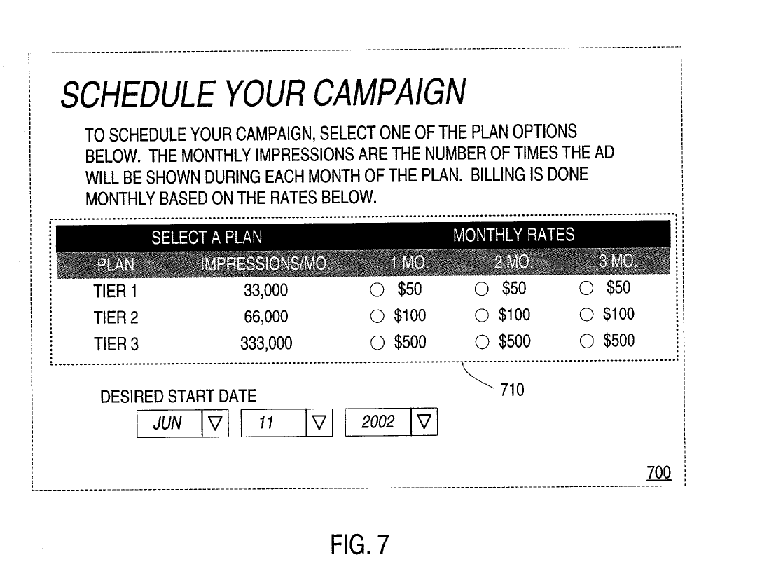

After a target has been specified, the advertiser is then presented with campaign scheduling screen 700 of FIG. 7. Campaign scheduling screen 700 is generally operative to enable the advertiser to select the scope of the campaign, including the start date of the campaign, the length of the campaign, the size of the campaign, or the like.

In the example of FIG. 7, a user is presented with a table 710 that lists the various campaign choices that are available. In this example, table 710 provides three plan tiers that define the numbers of impressions per campaign and the corresponding monthly rates. In general, the publisher can define the type of campaign choices that will be available for the advertiser. For example, the publisher can define various advertising campaigns that are based on the number of impressions, the number of clicks, a positional product (e.g., purchase of a position of a page for a period of time), etc. Further, the publisher can define the plan levels and the associated costs.

It is a feature of the present invention that publisher-specific campaign options are supported. These publisher-defined options can be stored in a database and retrieved dynamically for display to the advertiser.

After the advertising campaign is defined, the advertiser can then monitor the status of a running campaign. In one embodiment, the advertiser can view such campaign statistics as the numbers of impressions delivered, number of clicks on their ads, the clicks as a percentage of impressions served, or the like. These statistics are tracked and made available by the ASP-service.

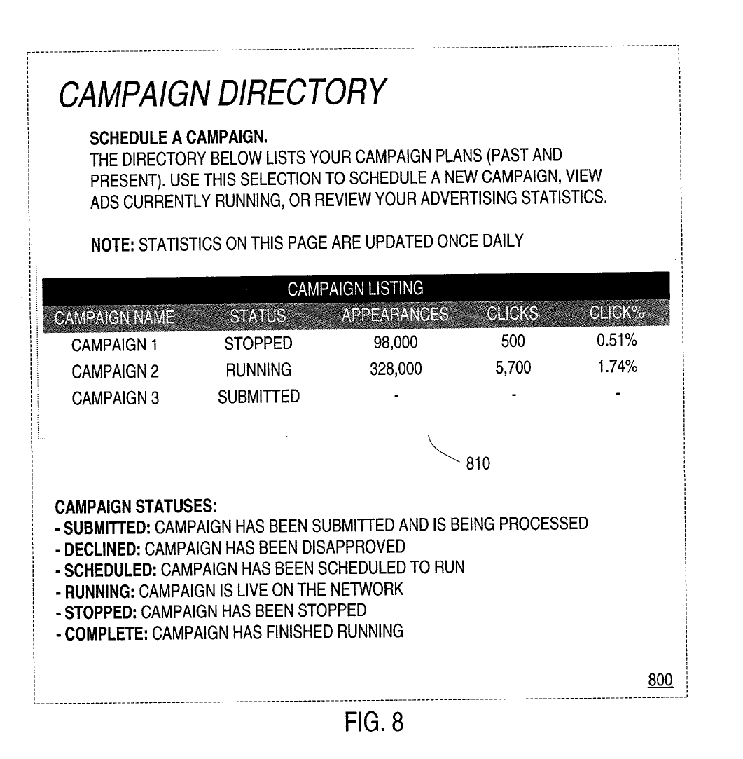

An embodiment of a campaign directory screen is illustrated in FIG. 8. Here, campaign directory screen 800 includes a table 810 that shows for each campaign, the status, the number of appearances, the number of clicks, and the click percentage for the campaign. In general, the campaign directory screen 800 enables an advertiser to determine the effectiveness of an ongoing campaign. These progress reports enable the advertiser to determine whether the campaign should be stopped or altered in any way.

As would be appreciated, if the publisher is solely offering advertising on their site, the data presented in campaign directory screen 800 is restricted to that site. This reporting “closes the loop”, giving the advertiser a means for evaluating the effectiveness of advertising on that particular site (or to a specific target on the site). This helps address the concerns regarding the value of Internet advertising, a concern that is affecting today's inventory levels.

As noted above, the ASP-service can be run as one instance of the application. The application is able to distinguish publishers (or affiliates), and in doing so retrieve the necessary information from database tables to display appropriate branding elements, ad types, templates, payment plans, etc. This makes the application appear to be unique to each affiliate, and makes the implementation of affiliates highly efficient.

All of the affiliates are given their own DNS (Domain Name Server) entry, which can be a combination of their company name and “advariant”. For example, the application can be accessed through the URL “http://<company name>.advariant.com”.

All requests go to a load-balancing server that establishes a session with one of a plurality of servers. The server will try to match requests for known affiliate names, and if found, rewrite the request to “http://advariant.com/mm/index.jsp?affiliate=<company name>”. In one embodiment, if the affiliate is not recognized, it defaults to “affiliate=amazingmedia”.

At this point, the affiliate is now identifiable as a query string parameter that gets appended to all subsequent requests. At the same time, a session has been established on the server with the client and the affiliate has been associated with the session. Maintaining the affiliate on the server protects against the client arbitrarily switching his affiliate by changing his URL.

As noted above, many components of the ASP-service may be customized based on a given affiliate. For example, rather than using a static HTML tag which would normally display a logo like <img src=“images/logo.gif” />, the ASP-service can use a dynamic tag like <img src=“images/<%=affiliateName%>/logo.gif” />where affiliateName is dynamically inserted at the time of the request. An affiliate-specific version of logo.gif would then be placed in a directory called images/<affiliateName>.

The ASP-service uses a similar technique to customize entire pages. For example, the index page (the first page in the application) can include an affiliate-specific page with a tag similar to <%@include file=“<%=affiliateName%>/index.jsp” %>. The same technique can also be used to customize an affiliate's privacy policy, terms and conditions, etc.

In general, customization of graphics and other HTML elements is only part of how affiliate applications can be dynamically generated. Affiliate data, including text within the HTML pages, can also be customized for specific affiliates. To dynamically generate a list of targets, for example, a SQL query embedded in the file can be used to generate dynamic HTML output. The code “select targetName from TargetCfg” is a simplified example of such a query. This example query would return all the target names from the TargetCfg table which would then be used to dynamically generate an HTML list (for select box, etc.) of target names.

In one embodiment, many of the queries would have a “where clause” which allows the data to be customized for affiliates. For example, the query “select targetName from TargetCfg where affiliateName=“<%=affiliatename%>”” would return only the target names associated with the specified affiliate.

In one embodiment, the major areas of application customization are defined by a number of “master” database tables as listed in Table 1. This data can be shared across many affiliates, or customized for a particular affiliate.

TABLE 1

| | |
|---|---|
| AffiliateCfg | Defines basic information about each Affiliate for |
| | internal tracking, UI display, and reporting. |
| AdSizeCfg | Defines available Ad sizes that a user can select from, |
| | including a display name and dimensions for each size |
| AdTypeCfg | Defines the available Ad types, e.g. Promote a |
| | Product, Promote a Service, etc. |
| AdTypeField | For each Ad type corresponding text and image fields |
| Cfg | are defined, e.g. Product Details, Product Image, etc. |
| AdTemplate | Each Ad type has corresponding Ad templates which |
| Cfg | allow the user to select a customized look and feel for |
| | the Ad. |
| TargetTypeCfg | Targets are categorized into types, Geographic, Interest |
| | Groups, Country, etc. |
| TargetCfg | Defines the specific Targets that can be chosen for a |
| | particular campaign, CA-Los Angeles, Technology, |
| | United States, etc. |
| Subscription | Defines basic information about Subscription plans that |
| PlanCfg | can be selected for a campaign. This includes the name |
| | of the plan (Silver, Gold, Platinum, etc.), the |
| | duration/number of installments, and the effective dates |
| | for a particular plan. |
| Subscription | Defines the detailed billing configuration for a |
| PlanInstallment | particular plan. Plans can be billed such that 2 months |
| Cfg | are charged for the first installment. Special |
| | promotions can also be configured allowing |
| | adjustments to the price and/or the number of |
| | impressions for any of the installments. (e.g. 5000 free |
| | impressions for the first month, first month free, etc.) |
| EmailCfg | Defines email templates that can be sent by the system |
| | when specified criteria are met. The criteria are |
| | specified by an SQL query which is stored in this table. |
| | The email is personalized by substituting database |
| | values into each email template. |
| ReportCfg | Defines individual reports that can be provided. |
| | Similar to EmailCfg, the query for the report is |
| | specified in this table. |

To allow for specific customization for each individual affiliate, another set of tables, as listed in Table 2, can be used to specify which data in the “master” tables applies to a particular affiliate. This structure provides significant flexibility in defining an affiliate's application, while easing overall administration by sharing the data from the master tables among the individual affiliates.

TABLE 2

| | |
|---|---|
| Affiliate | Maps the available Targets and Ad sizes for each |
| TargetAd | affiliate. Allows for individual customization of the |
| SizeCfg | Target names and sorting order. |
| Affiliate | Maps the available Ad types for each affiliate. Allows |
| AdTypeCfg | for individual customization of names, descriptions, |
| | and sorting order. |
| Affiliate | Maps the available Ad templates for each affiliate. |
| AdTemplate | Allows for individual customization of sorting order of |
| Cfg | the templates. |
| Affiliate | Maps the available Target types for each affiliate. |
| TargetTypeCfg | Allows for customization of the names. |
| Affiliate | Maps the available Subscription plans for each affiliate. |
| Subscription | Allows for customization of the names, effective dates, |
| PlanCfg | and sorting order. |
| Affiliate | Maps the specific emails available for this affiliate. |
| EmailCfg | |
| Affiliate | Maps the specific reports available for this affiliate. |
| ReportCfg | |

In general, ads that have been defined and deployed through the ASP-service can also be served by the ASP-service. In one embodiment, defined ads are served directly by the ASP-service through conventional ad-serving techniques. In another embodiment, defined ads are served based on a re-direct that is generated by a third-party ad server. In yet another embodiment, defined ads are provided to a third-party ad server, who is responsible for serving the ad. In this embodiment, the ASP-service plays no part in the actual serving of the ad.

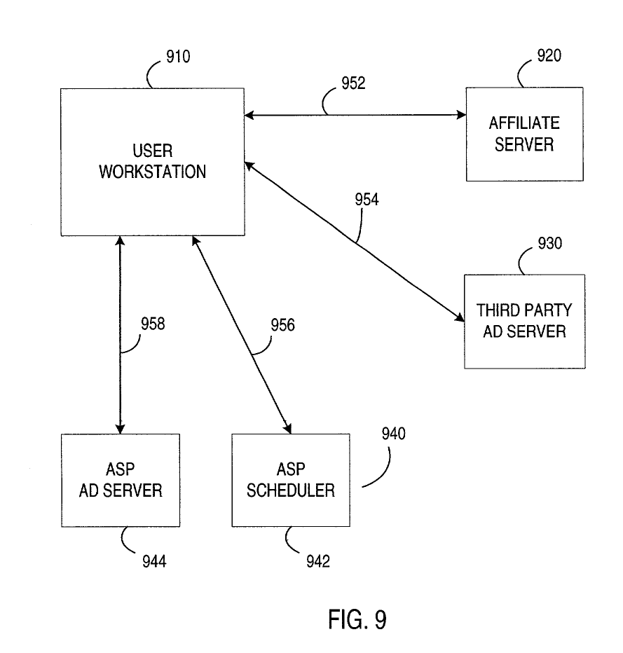

An embodiment of an ad serving network is illustrated in FIG. 9. In this embodiment, the ad delivery process begins when user workstation 910 contacts affiliate server 920 through session 952. Session 952 includes an HTTP request, sent from user workstation 910 to affiliate server 920, to get the information for the desired web page at the affiliate. Affiliate server 920 then responds by transmitting web page information, such as a compilation of hypertext markup language (HTML) code, JavaScript, Java applets, graphic image files (e.g., GIF, JPEG), etc., that is used by user workstation 910 in rendering the requested web page in the user's web browser interface.

As part of this compilation of web page information, affiliate server 920 also sends a tag (e.g., HTML tag) that identifies the source of the ad. Using the received tag, user workstation 910 can then transact with third party ad server 930 through session 954. Within session 954, user workstation 910 would send a message to third party ad server 930 to request the ad to be inserted into the web page.

Upon receipt of this request, third party ad server 930 could then determine whether it should initiate the delivery of the ad to user workstation 910 or whether it should redirect the ad request to another ad server. As would be appreciated, a scheduler associated with third party ad server 930 could be used to determine whether an ad request from user workstation 910 should be fulfilled by a campaign associated with inventory dedicated at least in part to the ASP-service. If the ad request should be fulfilled by the ASP-service, then third party ad server 930 would respond with a re-direct message to user workstation 910.

If a re-direct occurs, user workstation 910 would then transact with ASP service 940. In one embodiment, ASP service 940 would include ASP scheduler 942 and ASP ad server 944. In this embodiment, user workstation 910 would first transact with ASP scheduler 942 through session 956. As part of this transaction, ASP scheduler would provide user workstation 910 with code that would direct user workstation 910 to ASP ad server 944 for retrieval of the ad to be displayed.

User workstation 910 would then present an ad request to ASP ad server 944 through session 958. ASP ad server 944 would then locate the ad to be displayed, and transmit the ad to user workstation 910. User workstation 910 would then display the ad on the web page that is being rendered by user workstation 910.

While the invention has been described in detail and with reference to specific embodiments thereof, it will be apparent to one skilled in the art that various changes and modifications can be made therein without departing from the spirit and scope thereof.

For example, in an alternative embodiment, the ASP-service can be designed to run as an individual application for a particular affiliate. In general, the choice in the type of application would be based on implementation-dependant design parameters that are reflective of individual affiliate needs.

Additionally, it should be noted that the principles of the present invention can also be applied to advertising campaigns that are delivered in other contexts apart from an online web environment. For example, the principles of the present invention can be applied to any electronic-advertising context (e.g., email advertising) that seeks to provide greater measures of control to the advertising entities.

Thus, it is intended that the present invention cover the modifications and variations of this invention provided they come within the scope of the appended claims and their equivalents.

What is claimed is:

1. An advertising application service method, comprising:
receiving a request for an advertising application service, said request being generated based on a selection by a user of a link on a website of a publisher
transmitting a compilation of computer program logic that enables a user workstation to display a first user interface, said first user interface enabling a user to create an electronic ad;
transmitting second computer program logic that enables a user workstation to display a second user interface, said second user interface enabling a user to define a target of an ad campaign; and
transmitting third computer program logic that enables a user workstation to display a third user interface, said third user interface enabling a user to schedule said ad campaign.

2. The advertising application service method of claim 1, wherein said request includes an identifier of said publisher.

3. The advertising application service method of claim 1, wherein said first user interface enables a user to select an ad type.

4. The advertising application service method of claim 1, wherein said first user interface enables a user to define content of said electronic ad.

5. The advertising application service method of claim 1, wherein said first user interface enables a user to preview and select a created ad.

6. The advertising application service method of claim 1, wherein said second user interface enables a user to select a set of websites on which said electronic ad will be displayed.

7. The advertising application service method of claim 1, wherein said second user interface enables a user to select a portion of a website on which said electronic ad will be displayed.

8. The advertising application service method of claim 1, wherein said second user interface enables a user to select an audience to which said electronic ad will be displayed.

9. The advertising application service method of claim 1, wherein said third user interface enables a user to select a start date for said ad campaign.

10. The advertising application service method of claim 1, wherein said third user interface enables a user to select a duration of said ad campaign.

11. The advertising application service method of claim 1, wherein said third user interface enables a user to select a frequency of said ad campaign.

12. An advertising application service system, comprising:
a storage component that is configured to store advertising service options that are selected by a plurality of publishers;
a processing component capable of running a service that receives a request that is produced in response to interaction by a user with a web page of a publisher, determines that said request is associated with said publisher, and transmits computer program logic to a user workstation that enables said user workstation to display a user interface that enables a user to create an electronic ad and define an advertising campaign for said electronic ad, wherein said user interface includes advertising service options that have been selected by said publisher.

13. The advertising application service system of claim 12, wherein said service can be run as multiple instances.

14. The advertising application service system of claim 12, wherein each publisher is provided with a domain name server entry that includes an identifier of said publisher.

15. The advertising application service system of claim 12, wherein said advertising service option includes customized HTML.

16. The advertising application service system of claim 12, wherein said advertising service option includes customized ad types.

17. The advertising application service system of claim 12, wherein said advertising service option includes customized ad templates.

18. The advertising application service system of claim 12, wherein said advertising service option includes customized campaign targets.

19. The advertising application service system of claim 12, wherein said advertising service option includes customized campaign plans.
